(19) United States
(12) Patent Application Publication
(10) Pub. No.: US 2025/0181794 A1
(43) Pub. Date: Jun. 5, 2025

(54) METHODS FOR PROVIDING ONE OR MORE PREDICTIONS OF INCOMING BEHAVIOR OF A COMPUTING DEVICE

(71) Applicant: Microsoft Technology Licensing, LLC, Redmond, WA (US)

(72) Inventors: Bo DAN, Redmond, WA (US); Andrew Douglas DELANO, Woodinville, WA (US); Nanqiang ZHU, Bellevue, WA (US); Gregory Allen NIELSEN, Kirkland, WA (US)

(21) Appl. No.: 18/526,753

(22) Filed: Dec. 1, 2023

(51) Int. Cl. G06F 30/20; G06F 119/08

(52) U.S. Cl. CPC G06F 30/20; G06F 2119/08

(57) ABSTRACT

A computing device for predicting incoming behavior of the computing device is provided. The computing device may receive computing device measurement data historical telemetry data and live telemetry data and provide the computing device measurement data as an input to a virtual thermal device. The virtual thermal device may provide the one or more predictions of the incoming behavior of the computing device based on the computing device measurement data. The computing device may further provide the one or more predictions of the incoming behavior on a display.

### CROSS-REFERENCE TO RELATED APPLICATIONS

N/A

### BACKGROUND

All electronic devices generate heat that can cause various issues if not properly managed. For example, excess heat may cause reliability and performance issues, and even premature failure of components. Thermal management systems control the temperatures and ensures the components function in an optimal way. Proper thermal management may prolong the life of the electronic device.

### BRIEF SUMMARY

In some aspects, the techniques described herein relate to a method for providing one or more predictions of incoming behavior of a computing device, including: receiving computing device measurement data; providing the computing device measurement data as an input to a virtual thermal device; receiving, from the virtual thermal device, the one or more predictions of the incoming behavior of the computing device based on the computing device measurement data; and providing the one or more predictions of the incoming behavior on a display.

In some aspects, the techniques described herein relate to a method for providing one or more predictions of incoming behavior of a computing device and one or more options to prevent undesired incoming behavior, including: receiving computing device measurement data; providing the computing device measurement data as an input to a virtual thermal device; receiving, from the virtual thermal device, the one or more predictions of the incoming behavior of the computing device based on the computing device measurement data; receiving the one or more options to prevent the undesired incoming behavior; and providing the one or more predictions of the incoming behavior and the one or more options to prevent the undesired incoming behavior on a display.

In some aspects, the techniques described herein relate to a method for providing one or more options to prevent undesired incoming behavior of a computing device, and providing one or more options to prevent undesired thermal health predictions of the computing device, including: receiving computing device measurement data; receiving telemetry data of the computing device; receiving history data of the computing device; providing the computing device measurement data, the telemetry data, and the history data as an input to a virtual thermal device; receiving, from the virtual thermal device, one or more predictions of an incoming behavior of the computing device based on the computing device measurement data and the telemetry data, and one or more thermal health predictions based on the history data; receiving the one or more options to prevent the undesired incoming behavior and the one or more options to prevent the undesired thermal health predictions; and providing the one or more predictions of the incoming behavior, the one or more options to prevent the undesired incoming behavior, the one or more thermal health predictions, and the one or more options to prevent the undesired thermal health predictions on a display.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims or may be learned by the practice of such embodiments as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example of a computing device, in accordance with one embodiment.

FIG. 2 illustrates an example of an incoming behavior prediction system implemented on a computing device, in accordance with one embodiment.

FIG. 3 illustrates an example of a computing device, in accordance with one embodiment.

FIG. 4 illustrates an example of an incoming behavior prediction system implemented on a computing device, in accordance with one embodiment.

FIG. 5 illustrates an example of a computing device, in accordance with one embodiment.

FIG. 6 illustrates an example of a computing device, in accordance with one embodiment.

FIG. 7A is an example of a computing device, in accordance with one embodiment.

FIG. 7B is a cross sectional view of the computing device without the inner surface covers, in accordance with one embodiment.

FIG. 8 illustrates an example of building a virtual thermal device, in accordance with at least one embodiment.

FIGS. 9A and 9B illustrate an example of providing predictions of incoming behavior, thermal health predictions, and options to prevent them, in accordance with at least one embodiment.

FIG. 10 illustrates an example flowchart that includes a series of acts for providing one or more predictions of an incoming behavior of a computing device, in accordance with at least one embodiment.

FIG. 11 illustrates an example flowchart that includes a series of acts for providing one or more predictions of an incoming behavior of a computing device, in accordance with at least one embodiment.

FIG. 12 illustrates an example flowchart that includes a series of acts for providing one or more options to prevent an undesired incoming behavior of a computing device, and one or more options to prevent undesired thermal health predictions, in accordance with at least one embodiment.

FIG. 13 illustrates certain components that may be included within a computing system, in accordance with at least one embodiment.

### DETAILED DESCRIPTION

This disclosure generally relates to a system and method for predicting future behavior of a computing device. Thermal management is a necessary and important function of a computing device. When a user wants to increase performance of their computing device, it typically includes providing more power to one or more processors, such as a central processing unit (CPU), graphics processing unit (GPU), digital signal processor (DSP), application-specific integrated circuit (ASIC), and input/output processor (IOP). The more power provided to a processor means more heat is generated. A typical cooling method includes a fan with one or more fan outlets to distribute excess heat from inside of the computing device to outside. The faster the fan rotates, the more heat it can dissipate, but at the same time it, also generates more noise, which can be unpleasant for a user. For example, for a user who suffers from an extreme sensitivity to sounds (e.g., misophonia), a loud fan noise may cause extreme emotional reactions or even anxiety. Without performing adequate cooling, the computing device may overheat, causing high skin temperatures, and may ultimately cause a premature failure of one or more components.

Typically, a thermal management system of a computing device is configured to keep the internal temperature below a threshold by either increasing cooling (such as fan speed), or lowering the power provided for a processor. Some computing devices may allow a user to select either a high-performance mode or a low-performance mode. A high-performance mode may prioritize providing high power to one or more components with the expense of battery life and temperature increase, whereas a low-performance mode prioritizes a long battery life and low component temperatures over processor performance speed. A user who cares about longevity of their computing device may choose to use a low-performance mode, and a user who does not care about longevity of their computing device may choose a high-performance mode. In either situation, a typical thermal management system will automatically adjust its performance based on heat generated during the use of the computing device. A user may not know what events may increase or decrease heat generation, nor will they know when a change in thermal condition will occur. Furthermore, since they do not know the thermal behavior of their computing device, they cannot take preventive actions beforehand if a thermal behavior of their computing device is going to change.

The features and functionalities described herein provide a number of advantages and benefits over conventional approaches and systems. For example, the systems and methods described herein provide features and functionality related to predicting thermal behavior of a computing device. For example, by providing predictions of thermal behavior, a user may choose to take actions that may prevent any unwanted thermal behaviors.

In addition to providing predictions on thermal behavior, the systems and method further provide features and functionality related to providing predictions on thermal health of a computing device. For example, by providing predictions on thermal health of a computing device a user may prepare for any device health degradations by taking precautions, or by taking actions that may prolong the computing device's service life.

It should be noted that the advantages and benefits discussed herein are provided by way of example and are not intended to be an exhaustive list of all possible advantages and benefits of implementations of the systems and methods for predicting thermal behavior and thermal health of a computing device.

As illustrated in the foregoing discussion, the present disclosure utilizes a variety of terms to describe features and advantages of one or more embodiments of the thermal behavior prediction. Additional detail will now be provided regarding the meaning of some of these terms. Further terms will also be discussed in detail in connection with one or more embodiments and specific examples below.

In one or more embodiments described herein, a “skin temperature” refers to a temperature measured from a skin (e.g., the housing that is touchable by a user) of a computing device. Different skin parts may have different skin temperatures measured at the same point in time, as heat dissipates even along the skin. Hence, typically the skin temperature is warmest closest to the processor location and gradually cools down as moving further away from the processor.

As used herein, a “thermal behavior” refers to a thermal change in a computing device. For example, it may mean higher/lower component temperature, higher/lower skin temperature, higher/lower fan speed, higher/lower acoustic noise level, and/or higher/lower processor power. In general, a thermal behavior refers to change that will take place in real-time or in a short amount of time. In practice, a thermal behavior is used to signify a change from a current thermal condition to a new thermal condition. For example, when a fan is turned ON to cool down a component, or when a skin temperature increases due to increase in component heat.

As used herein, a “thermal health” refers to a computing device's long-term health that is significantly related to thermal behavior of the computing device. For example, the thermal health may indicate long-term health of various components on a computing device. For example, a thermal health may indicate an amount of time for a battery failure, a storage failure, a CPU failure, or any other component or system failure. In practice, a thermal health indicates a change that may take place over a long time period (such as months or years).

As used herein, “measurement data” refers to data collected by a sensor. Such as a temperature sensor, a power usage sensor, a fan speed sensor, a battery charge & discharge sensor, a display brightness detection sensor, etc. Measurement data may be collected by a sensor that is located either inside or outside of the computing device. For example, a GPU temperature sensor is located inside of a computing device in close proximity of a GPU component to accurately measure the temperature of the GPU component. In another example, an ambient temperature sensor is located outside of a computing device to accurately measure the ambient temperature surrounding the computing device. In one or more embodiments, a sensor may be a physical hardware sensor (e.g., a component that is configured to perform the measurement detection, such as a temperature sensor). In one or more embodiments, a sensor may be a software that is configured to detect the measurement data (e.g., a software that detects display brightness). In one or more embodiment, a sensor is a combination of a software and hardware sensors.

As used herein, “telemetry data” is data collected from the operating system (OS) that indicates which applications and components are being used at a specific point in time. For example, telemetry data may include whether one or more communication interfaces are being used, such as Universal Serial Bus (USB), a Bluetooth wireless communication adapter, or a wireless adapter (such as a Wi-Fi). In another example, telemetry data may include whether a browser, a word processing application, a chat application, a calendar application, etc., are being used. Telemetry data may include powers of core components (e.g., CPU, GPU, system), temperatures from sensors, and fan speed.

As used herein, “history data” includes a long-term measurement data and a long-term telemetry data that provides computing device history on a thermal behavior, a power consumption behavior, a battery usage behavior, a display brightness behavior, etc. In one or more embodiments history data may be “raw data,” meaning individual data collected at various different points in time during a long time period. Raw data is data that has not been analyzed prior. In one or more embodiments, history data includes analyzed data, such as a number of thermal cycles performed by the computing device, a number of critical temperatures reached, a length of time a critical temperature was experienced, a proportion of time spent on high power mode versus a battery saving mode, etc. In general, history data provides information about the general usage of the computing device over a long period of time.

As used herein, “thermal cycling” refers to a repeated temperature change between two extreme temperatures, a high temperature and a low temperature. Thermal cycling may cause various different problem on a computing device when energy (i.e., heat) flows through several layers of tightly stacked materials. Thermal cycling may cause thermal fatigue which may lead to solder weakness, warpage, breaking, cracking, and eventually a device failure.

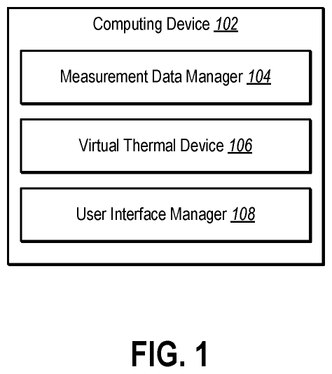

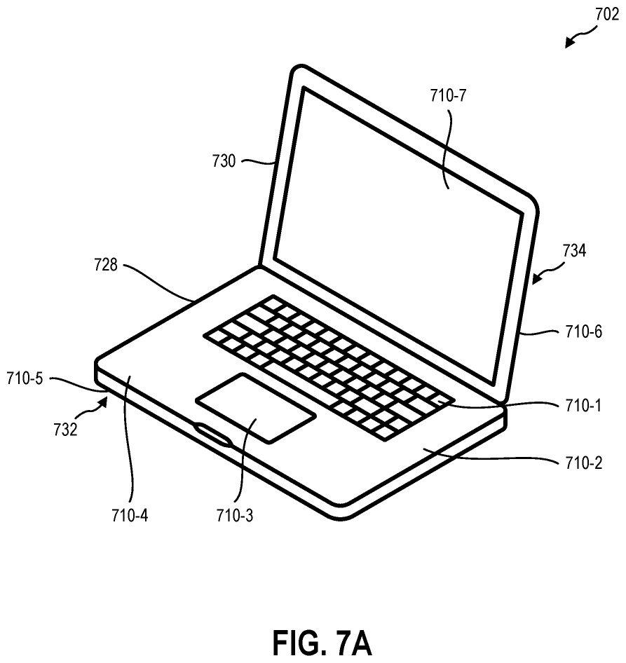

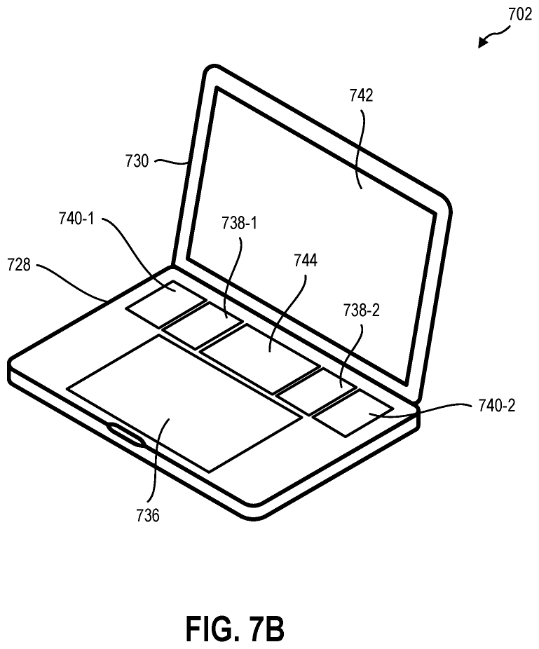

FIG. 1 illustrates an example of a computing device 102 in accordance with one or more embodiments. In one or more embodiments, the computing device 102 may be a personal electronic device, such as a mobile phone, a laptop, a personal computer, a tablet, a gaming device, a smartwatch, etc. In one or more embodiments, the computing device 102 may be an industrial electronic device, such as a cloud computing device, a server, a router, etc. In one or more embodiments, the computing device 102 includes a measurement data manager 104. In one or more embodiments, the measurement data manager 104 is configured to receive computing device measurement data from one or more sensors. For example, the measurement data manager 104 may receive temperature data from one or more sensors. In another example, the measurement data manager 104 may receive power usage data from one or more processors. In a further example, the measurement data manager 104 may receive fan rotation speed measurements. In yet another example, the measurement data manager 104 may receive battery charge and discharge measurements. In another example, the measurement data manager 104 may receive display brightness measurements. Additional details of a measurement data are further discussed in connection to FIGS. 7A and 7B.

As shown in FIG. 1, the computing device 102 includes a virtual thermal device 106. In one or more embodiments, the virtual thermal device 106 is a prediction model built from a simulation data. For example, by simulating the computing device's thermal behavior in various different circumstances (e.g., different ambient temperatures, different processor power usage, different fan speeds, different display brightness, etc.), a computing device's thermal behavior may be modeled with the simulation data. In one or more embodiments, the virtual thermal device 106 is a prediction model built from collecting actual measurements data from a prototype device that is capable to simulate real-time thermal behavior of the computing device in various different circumstances. In one or more embodiments, the virtual thermal device 106 is a prediction model built by both the simulation data and the actual measurement data collected from a prototype device. For example, a first model may be built with simulation data, and the first model may be further fine-tuned and/or verified with the actual measurement data collected from a prototype. In one or more embodiments, a regression model is built based on the one or more of simulation data or actual measurement data collected from a prototype. For example, the regression model may be a linear regression model or a non-linear regression model.

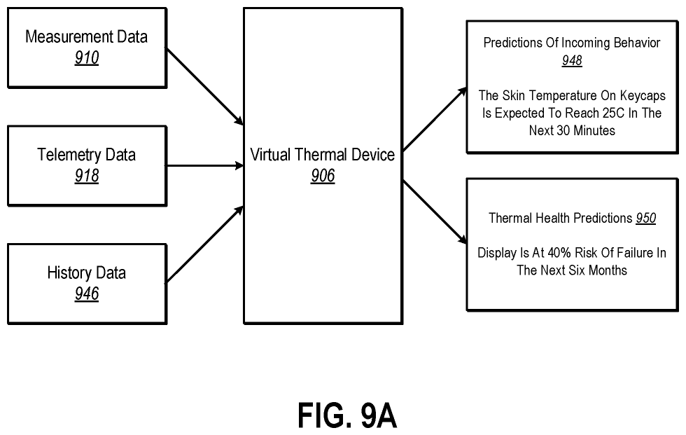

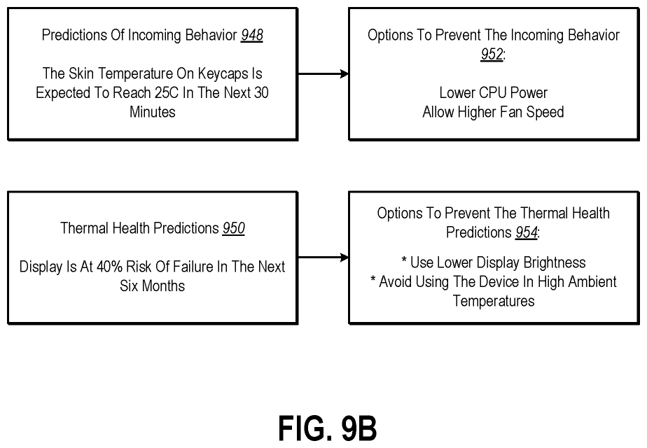

In one or more embodiments, the measurement data manager 104 provides the measurement data as an input to the virtual thermal device 106. The virtual thermal device 106 is then configured to provide one or more predictions of incoming behavior of the computing device 102 based on the measurement data. For example, a prediction of incoming behavior may be a change in thermal condition on one or more components of the computing device 102. For example, a prediction may be that the computing device will need to reduce power to one or more processors due to the incoming overheating. Additional examples of predictions are further discussed in connection with FIGS. 9A and 9B.

As shown in FIG. 1, the computing device 102 further includes a user interface manager 108. In one or more embodiments, the user interface manager 108 is configured to provide the one or more predictions of the incoming behavior on a display of the computing device 102. For example, the prediction may be provided as a notification on the display wherein the full notification is viewable after the user selects to read the notification by selecting it on the display. In another example, the prediction may be provided as a permanent banner on the screen that the user must interact with first before they are able to continue with other tasks.

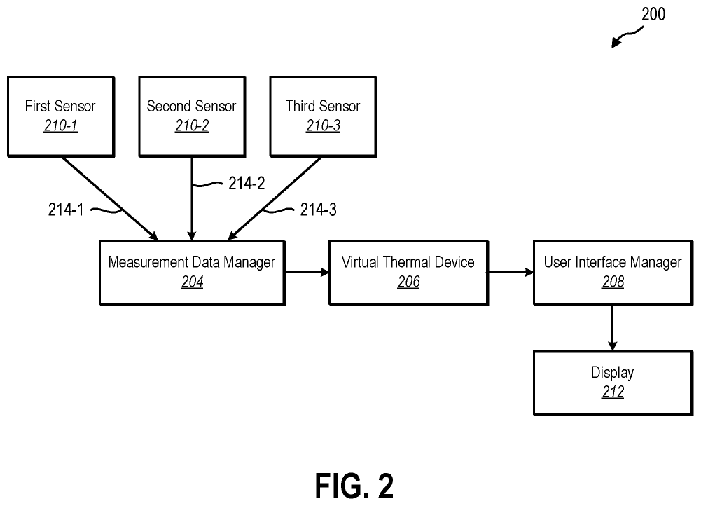

FIG. 2 illustrates an example of an incoming behavior prediction system 200 implemented on a computing device in accordance with one or more embodiments. The system includes a first sensor 210-1, a second sensor 210-2, and a third sensor 210-3. For example, the first sensor 210-1 may be a temperature sensor configured to measure a temperature of a processor, the second sensor 210-2 may be a temperature sensor configured to measure an ambient temperature, and the third sensor 210-3 may be a rotation sensor configured to measure fan rotation speed. A measurement data manager 204, such as the measurement data manager 104 of FIG. 1, receives the temperature of a processor 214-1, the ambient temperature 214-2, and the fan rotation speed 214-3. For example, the temperature of the processor 214-1 may be 43 degrees of Celsius, the ambient temperature 214-2 may be 27 degrees of Celsius, and the fan rotation speed may be 2000 rounds per minute (rpm). In one or more embodiments, the measurement data received by the measurement data manager 204 are real-time measurements measured in close proximity of time.

The measurement data manager 204 provides the temperature of the processor 214-1, the ambient temperature 214-2, and the fan rotation speed 214-3 to a virtual thermal device 206, such as the virtual thermal device 106 of FIG. 1. In one or more embodiments, the virtual thermal device 206 is a prediction model built from simulation data. In one or more embodiments, the prediction model is built from collecting actual measurement data from a prototype device that is capable of simulating real-time thermal behavior of the computing device in various different circumstances. In one or more embodiments, the virtual thermal device 206 is a prediction model built by both the simulation data and the actual measurement data collected from a prototype device.

The virtual thermal device 206 is configured to input the measurement data (214-1, 214-2, and 214-3) to the prediction model and to provide one or more predictions of the incoming behavior of the computing device as an output from the model. For example, based on the measurement data, the prediction model may predict that the processor temperature is going to increase under the current conditions by ten degrees (for example, from the measured 43 degrees to 53 degrees) and hence the fan speed needs to be increased due to the increase in temperature expected to take place in a relatively short period of time in the future (for example, in the next twenty minutes).

The virtual thermal device 206 then provides the one or more predictions of the incoming behavior on a user interface manger 208 which is configured to display the one or more predictions on a display 212 of the computing device.

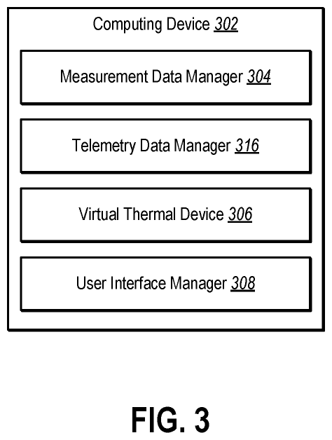

FIG. 3 illustrates an example of a computing device 302 in accordance with one or more embodiments. In one or more embodiments, the computing device 302 may be the computing device 102 as previously discussed in connection with FIG. 1, including a measurement data manager 304, a virtual thermal device 306, and a user interface manager 308. In one or more embodiments, the computing device 302 further includes a telemetry data manager 316. A telemetry data manager 316 is configured to receive telemetry data from an operating system (OS). For example, telemetry data may include real-time data about applications running on the computing device 302 at a specific point in time. The telemetry data provides additional information to the virtual thermal device 306 for predicting incoming behavior of the computing device.

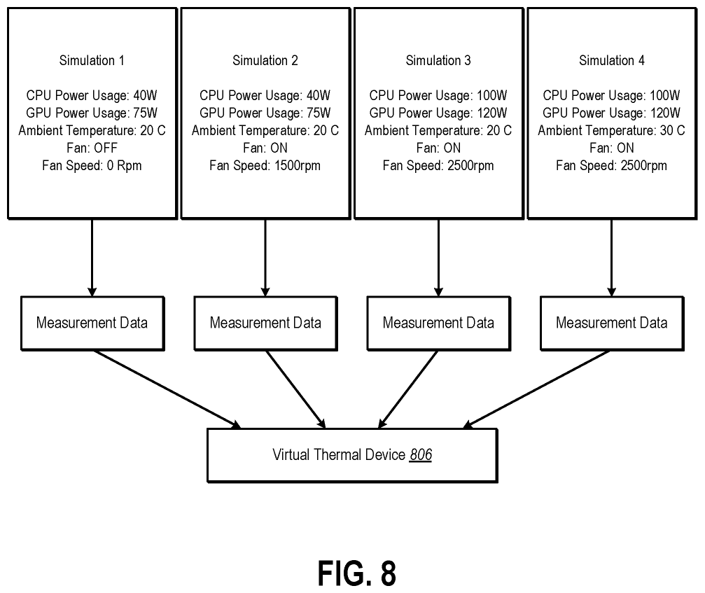

In one or more embodiments, the virtual thermal device 306 is a prediction model built from simulation data. For example, by simulating the computing device's thermal behavior in various different circumstances (e.g., different ambient temperatures, different processor power usage, different fan speeds, different display brightness, different application usage), a computing device's thermal behavior may be modeled with the simulation data. In one or more embodiments, the virtual thermal device 306 is a prediction model built from collecting actual measurements data from a prototype device that is capable of simulating real-time thermal behavior of the computing device in various different circumstances. In one or more embodiments, the virtual thermal device 306 is a prediction model built by both the simulation data and the actual measurement data collected from a prototype device. Additional details about building the virtual thermal device are further discussed in connection with FIG. 8.

In one or more embodiments, the measurement data manager 304 provides the measurement data and the telemetry data manager 316 provides the telemetry data as an input to the virtual thermal device 306. The virtual thermal device 306 is then configured to provide one or more predictions of incoming behavior of the computing device 302 based on the measurement data and the telemetry data. For example, a prediction of incoming behavior may be a change in thermal condition on one or more components of the computing device 302. For example, a prediction may be that the computing device will need to reduce power to one or more processors due to overheating. Additional examples of predictions are further discussed in connection with FIGS. 9A and 9B.

As shown in FIG. 3, the computing device 302 further includes a user interface manager 308. In one or more embodiments, the user interface manager 308 is configured to provide the one or more predictions of the incoming behavior on a display of the computing device 302. For example, the prediction may be provided as a notification on the display wherein the full notification is viewable after the user selects to read the notification by selecting it on the display. In another example, the prediction may be provided as a permanent banner on the screen that the user must interact with first before they are able to continue with other tasks.

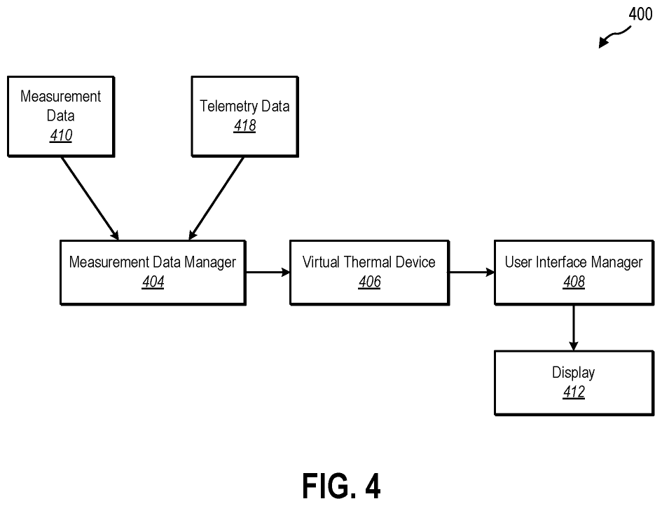

FIG. 4 illustrates an example of an incoming behavior prediction system 400 implemented on a computing device in accordance with one or more embodiments. The system includes measurement data 410 and telemetry data 418 collected by a measurement data manager 404. For example, the measurement data 410 may be temperature data from various different temperature sensors, power usage data, fan speed data, battery charge & discharge data, and display brightness data. In one or more embodiments, the telemetry data may include information about different applications running in the computing device. For example, a browser, a word processing software, a video player, etc. In one or more embodiments, the telemetry data includes information about communication interfaces that are in use. For example, a USB, a Bluetooth, or a Wi-Fi interface.

The measurement data manager 404 is configured to provide the collected measurement data 410 and the telemetry data 418 to a virtual thermal device 406. In one or more embodiments, the virtual thermal device 406 is a prediction model built from simulation data. For example, by simulating the computing device's thermal behavior in various different circumstances (e.g., different ambient temperatures, different processor power usage, different fan speeds, different display brightness, different application usage), a computing device's thermal behavior may be modeled with the simulation data. In one or more embodiments, the virtual thermal device 406 is a prediction model built from collecting actual measurement data from a prototype device that is capable of simulating real-time thermal behavior of the computing device in various different circumstances. In one or more embodiments, the virtual thermal device 406 is a prediction model built by both the simulation data and the actual measurement data collected from a prototype device. Additional details about building the virtual thermal device are further discussed in connection with FIG. 8.

Similarly, as the incoming behavior prediction system 200 in FIG. 2, the incoming behavior prediction system 400 in FIG. 4 is then configured to provide the one or more predictions of the incoming behavior of the computing device based on the measurement data and the telemetry data. A user interface manager 408 is then configured to display the one or more predictions on a display 412.

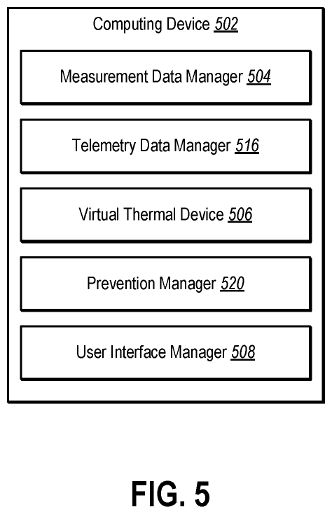

FIG. 5 illustrates an example of a computing device 502 in accordance with one or more embodiments. In one or more embodiments, the computing device 502 may be the computing device 102 as previously discussed in connection with FIG. 1, or the computing device 302 as previously discussed in connection with FIG. 3. The computing device 502 includes a measurement data manager 504, a telemetry data manager 516, a virtual thermal device 506, and a user interface manager 508. These components may perform similar actions as the measurement data manager 304, the telemetry data manager 316, the virtual thermal device 306, and the user interface manager 308 as previously discussed in connection with FIG. 3.

In one or more embodiments, the computing device 502 further includes a prevention manager 520. A prevention manager 520 is configured to provide options to prevent the one or more predictions of the incoming behavior. For example, the prevention manager 520 may provide an option to lower a power submitted to a processor, to increase a fan speed above a noise threshold, to lower a display brightness, to disconnect from a charger, to change to a higher power supply unit (PSU), to disconnect from a network, or to close some applications that are running in the computing device. The user interface manager 508 is then configured to display both the one or more predictions of the incoming behavior and the one or more options to prevent the one or more predictions of the incoming behavior.

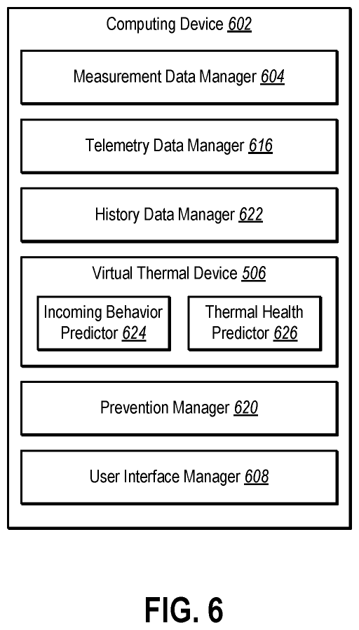

FIG. 6 illustrates an example of a computing device 602 in accordance with one or more embodiments. In one or more embodiments, the computing device 602 may be the computing device 102 as previously discussed in connection with FIG. 1, the computing device 302 as previously discussed in connection with FIG. 3, or the computing device 502 as previously discussed in connection with FIG. 5. The computing device 602 includes a measurement data manager 604, a telemetry data manager 616, a virtual thermal device 606, a prevention manager 620, and a user interface manager 608. These components may perform similar actions as the measurement data manager 504, the telemetry data manager 516, the virtual thermal device 506, the prevention manager 520, and the user interface manager 508 as previously discussed in connection with FIG. 5.

The computing device 602 may further include a history data manager 622. In one or more embodiments, the history data manager 622 is configured to collect history data. For example, history data includes long-term measurement data and long-term telemetry data that provides computing device history on a thermal behavior, a power consumption behavior, a battery usage behavior, a display brightness behavior, etc. In one or more embodiments a history data may be “raw data,” meaning individual data collected at various different points in time during a long time period. Raw data is data that has not been analyzed prior. In one or more embodiments, history data includes analyzed data based on the raw data, such as a number of thermal cycles performed by the computing device, a number of critical temperatures reached, a length of time a critical temperature was experienced, a proportion of time spent on high power mode versus a battery saving mode, etc. In general, history data provides information about the general usage of the computing device over a long period of time.

As shown in FIG. 6, the virtual thermal device 606 includes an incoming behavior predictor 624 and a thermal health predictor 626. The incoming behavior predictor 624 predicts a short-term thermal behavior of the computing device based on measurement data and telemetry data, such as discussed in connection with prior figures. The thermal health predictor 626 predicts a long-term failure of different components, such as the battery, the display, the one or more processors, and the thermal management system of the computing device. For example, the thermal health predictor 626 may receive as an input a number of charging and discharging cycles of the battery, temperature exposures, and use patterns, and the thermal health predictor 626 may predict based on the received data that the rate of battery capacity loss will be 5% for the next one year. In another example, the thermal health predictor 626 may receive as an input a number of thermal cycles, a number of critical temperatures experienced by a processor, and the amount of time the computing device is used in high performance mode, and the thermal health predictor 626 may predict based on the received data that the processor is likely going to fail in the next two years.

In one or more embodiments, the prevention manager 620 is configured to provide options to prevent one or more of the predicted incoming behaviors (e.g., the short-term predictions) and the one or more thermal health predictions (e.g., the long-term predictions). The user interface manager 608 is then configured to display the one or more predictions of the incoming behavior and options to prevent them, and the one or more thermal health predictions and options to prevent them.

FIG. 7A is an example of a computing device 702 according with any of the computing devices (102, 202, 302, 402, 502, 602) discussed in connection with prior figures. The computing device 702 includes a first part 728 and a second part 730, wherein an inner surface of the first part 728 and an inner surface of the second part 730 are configured to come in contact with each other. The first part 728 further includes an outer surface 732 and the second part 730 further includes an outer surface 734.

In one or more embodiments, the computing device 702 includes plurality of sensors where measurement data can be collected. As shown in FIG. 7A, the computing device 702 includes a keycap temperature sensor 710-1, a right palm-rest temperature sensor 710-2, touch pad temperature sensor 710-3, a left palm-rest temperature sensor 710-4, an outer surface temperature sensor 710-5 for the outer surface 732 of the first part 728, an outer surface temperature sensor 710-6 for the outer surface 734 of the second part 730, and a display temperature sensor 710-7.

FIG. 7B is a cross sectional view of the computing device 702 without the inner surface covers in accordance with one or more embodiments. In one or more embodiments, the computing device 702 includes a plurality of sensors where measurement data can be collected. As shown in FIG. 7B the computing device 702 includes a battery sensor 736, a first processor sensor 738-1, a second processor sensor 738-2, a first fan 740-1 for the first processor and a second fan 740-2 for the second processor, a storage unit sensor 744, and a display brightness sensor 742. In one or more embodiments, the collected measurement data may be used to provide one or more predictions of the incoming behavior and/or thermal health predictions.

FIG. 8 illustrates an example of building a virtual thermal device in accordance with at least one embodiment. As shown in FIG. 8, a plurality of simulations is run with different variables. In one or more embodiments, the plurality of simulations is run with a simulator that simulates the thermal behavior of the computing device and is able to provide simulated measurement data. In one or more embodiments, the simulations are run with a physical prototype and actual measurement data can be collected from the physical prototype.

In the example shown in FIG. 8, the simulations are run with four different variables. Each of the four variables may include a plurality of different values. Each of the simulation will run a different combination of different variable values. For example, simulation 1 and simulation 2 differ only on the fact that simulation 2 has a fan rotating at a speed of 1500 rpm, while simulation 1 has fan turned off. Simulation 3 and simulation 4 differ only on the fact that simulation 3 has a lower ambient temperature (20 C), while simulation 4 has a higher ambient temperature (30 C). In one or more embodiments, the CPU power usage may range between 0 W and 150 W, the GPU power usage may range between 0 W and 300 W, an ambient temperature may range between −10 C and +40 Celsius a fan speed may range from 0 rpm and 5000 rpm. Simulations with different combinations of the value of CPU power usage, GPU power usage, ambient temperature, and fan speed will be performed based on one or more DOE (Design of Experiment) designs.

As a result of the simulations, measurement data is collected, either from the simulation device, or from the physical prototype. This measurement data may be the measurement data collected as shown in connection with FIGS. 7A and 7B. The collected measurement data together with the variables are then used to build the virtual thermal device 806. For example, the system may build a regression model that models the thermal behavior of a computing device.

FIGS. 9A and 9B illustrate an example of providing predictions of incoming behavior, thermal health predictions, and options to prevent them. As shown in FIG. 9A, a virtual thermal device 906 receives measurement data 910, telemetry data 918, and history data 946. Based on the received data, the virtual thermal device 906 is configured to provide one or more predictions of incoming behavior 948 and one or more thermal health predictions 950. As shown in FIG. 9A, the predictions of incoming behavior 948 include a prediction that the skin temperature on keycaps is expected to reach 45 Celsius in the next 30 minutes. A thermal health prediction 950 includes a prediction that a display is at 40% risk of failure in the next six months. Based on the predictions of incoming behavior 948 and the one or more thermal health predictions 950, one or more options are provided to prevent them. As shown in FIG. 9B, two options 952 are provided to prevent the incoming behavior of skin temperature on keycaps to reach 45 C. A first option provided is to lower a CPU power, and a second option is to allow higher fan speed. Two options 954 are also provided to prevent the high risk of display failure. A first option provided is to lower display brightness, and a second option is to avoid using the computing device in high ambient temperatures. In one or more embodiments, the predictions and the options may be provided on a display. For example, the predictions may be provided as a notification, and the options may include links or additional details on how to choose the options (e.g., how to lower CPU battery power).

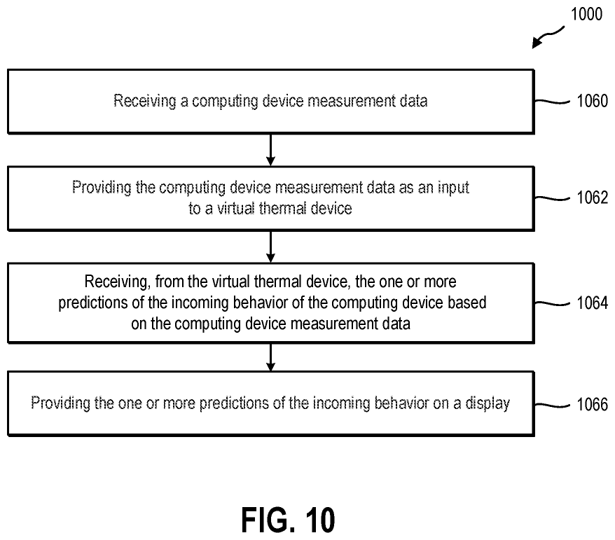

FIG. 10 illustrates an example flowchart that includes a series of acts 1000 for providing one or more predictions of an incoming behavior of a computing device. In particular, FIG. 10 illustrates an example series of acts of a computer-implemented system and method for providing one or more predictions of an incoming behavior of a computing device by using measurement data in accordance with one or more embodiments. While FIG. 10 illustrates acts according to one or more embodiments, alternative embodiments may omit, add to, reorder, and/or modify any of the acts shown. Furthermore, the acts of FIG. 10 can be performed as part of a method (e.g., a computer implemented method). Alternatively, a computer-readable medium can include instructions that, when executed by a processing system having a processor, cause a computing device to perform the acts of FIG. 10. In some implementations, a system (e.g., a processing system comprising a processor) can perform the acts of FIG. 10. For example, the system includes a processing system and a computer memory including instructions that, when executed by the processing system, cause the system to perform various actions or steps.

As shown in FIG. 10, the series of acts 1000 includes an act 1060 of receiving computing device measurement data. In one or more embodiments, the computing device measurement data is received from one or more sensors. For example, the measurement data may include one or more of a CPU temperature, a GPU temperature, a CPU power usage, a GPU power usage, a battery temperature, an ambient temperature, a display brightness measurement, battery charge and discharge measurements, and a fan rotation speed measurement.

The series of acts 1000 further includes an act 1062 of providing the computing device measurement data as an input to a virtual thermal device. In one or more embodiments, the virtual thermal device is a prediction model built from simulation data. For example, it may be a regression model.

The series of acts 1000 further includes an act 1064 of receiving, from the virtual thermal device, the one or more predictions of the incoming behavior of the computing device based on the computing device measurement data. In one or more embodiments, the one or more predictions of the incoming behavior relate to one or more of a fan noise level change, a battery level change, a power consumption change, or a skin temperature change.

The series of acts 1000 further includes an act 1066 of providing the one or more predictions of the incoming behavior on a display. For example, the one or more predictions of the incoming behavior may be displayed on a remote display or on a display that is an integral part of the computing device.

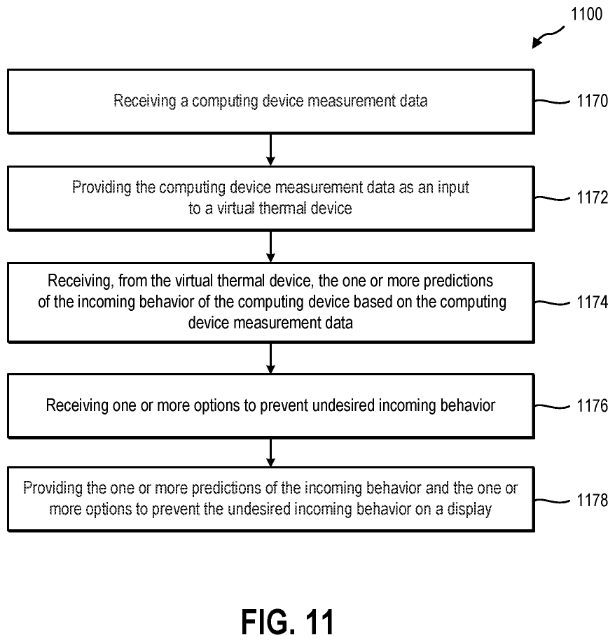

FIG. 11 illustrates an example flowchart that includes a series of acts 1100 for providing one or more predictions of an incoming behavior of a computing device. In particular, FIG. 11 illustrates an example series of acts of a computer-implemented system and method for providing one or more predictions of an incoming behavior of a computing device by using measurement data in accordance with one or more embodiments. While FIG. 11 illustrates acts according to one or more embodiments, alternative embodiments may omit, add to, reorder, and/or modify any of the acts shown. Furthermore, the acts of FIG. 11 can be performed as part of a method (e.g., a computer implemented method). Alternatively, a computer-readable medium can include instructions that, when executed by a processing system having a processor, cause a computing device to perform the acts of FIG. 11. In some implementations, a system (e.g., a processing system comprising a processor) can perform the acts of FIG. 11. For example, the system includes a processing system and a computer memory including instructions that, when executed by the processing system, cause the system to perform various actions or steps.

As shown in FIG. 11, the series of acts 1100 includes an act 1170 of receiving computing device measurement data. In one or more embodiments, the computing device measurement data is received from one or more sensors. For example, the measurement data may include one or more of a CPU temperature, a GPU temperature, a CPU power usage, a GPU power usage, a battery temperature, an ambient temperature, a display brightness measurement, battery charge and discharge measurements, and a fan rotation speed measurement.

The series of acts 1100 further includes an act 1172 of providing the computing device measurement data as an input to a virtual thermal device. In one or more embodiments, the virtual thermal device is a prediction model built from simulation data. For example, it may be a regression model.

The series of acts 1100 further includes an act 1174 of receiving, from the virtual thermal device, the one or more predictions of the incoming behavior of the computing device based on the computing device measurement data. In one or more embodiments, the one or more predictions of the incoming behavior relate to one or more of a fan noise level change, a battery level change, a power consumption change, or a skin temperature change. For example, the skin temperature change is one or more of a skin temperature change on a keycap, on a palm-rest, on a touch pad, on a display, or on an outer surface.

The series of acts 1100 further includes an act 1176 of receiving one or more options to prevent the one or more predictions of the incoming behavior. For example, the one or more options may include an option to lower a power submitted to a processor, to increase a fan speed above a noise threshold, to lower a display brightness, to disconnect from a charger, to change to a higher power supply unit (PSU), to disconnect from a network, or to close some applications that are running in the computing device.

The series of acts 1100 further include an act 1178 of providing the one or more predictions of the incoming behavior and the one or more options to prevent the one or more predictions on a display. For example, the one or more predictions of the incoming behavior may be displayed on a remote display or on a display that is an integral part of the computing device.

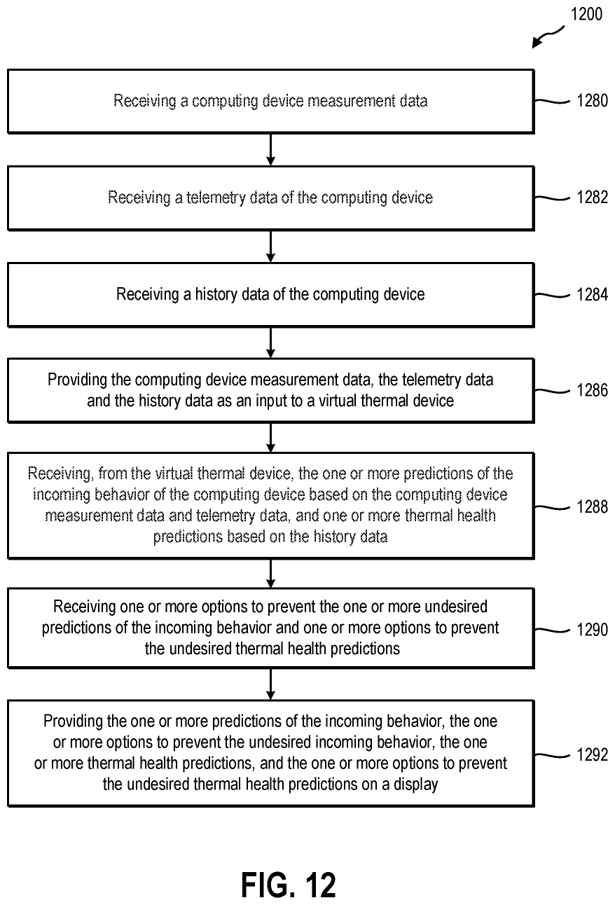

FIG. 12 illustrates an example flowchart that includes a series of acts 1200 for providing one or more options to prevent an undesired incoming behavior of a computing device, and one or more options to prevent undesired thermal health predictions. In particular, FIG. 12 illustrates an example series of acts of a computer-implemented system and method for providing one or more predictions of an incoming behavior of a computing device by using measurement data, providing one or more thermal health predictions based on history data, and one or more options to prevent them in accordance with one or more embodiments. While FIG. 12 illustrates acts according to one or more embodiments, alternative embodiments may omit, add to, reorder, and/or modify any of the acts shown. Furthermore, the acts of FIG. 12 can be performed as part of a method (e.g., a computer implemented method). Alternatively, a computer-readable medium can include instructions that, when executed by a processing system having a processor, cause a computing device to perform the acts of FIG. 12. In some implementations, a system (e.g., a processing system comprising a processor) can perform the acts of FIG. 12. For example, the system includes a processing system and a computer memory including instructions that, when executed by the processing system, cause the system to perform various actions or steps.

As shown in FIG. 12, the series of acts 1200 includes an act 1280 of receiving computing device measurement data. In one or more embodiments, the computing device measurement data is received from one or more sensors. For example, the measurement data may include one or more of a CPU temperature, a GPU temperature, a CPU power usage, a GPU power usage, a battery temperature, an ambient temperature, a display brightness measurement, battery charge and discharge measurements, and a fan rotation speed measurement.

The series of acts 1200 further includes an act 1282 of receiving telemetry data of the computing device. For example, the telemetry data includes one or more of information about applications that are running in the computing device, or communication interfaces being used.

The series of acts 1200 further includes an act 1284 of receiving history data of the computing device. For example, the history may include long-term measurement data and long-term telemetry data collected over a long period of time.

The series of acts 1200 further include an act 1286 of providing the computing device measurement data, the telemetry data, and the history data as an input to a virtual thermal device. In one or more embodiments, the virtual thermal device is a prediction model built from simulation data. For example, it may be a regression model.

The series of acts 1200 further includes an act 1288 of receiving, from the virtual thermal device, the one or more predictions of the incoming behavior of the computing device based on the computing device measurement data and telemetry data, and one or more thermal health predictions based on the history data. In one or more embodiments, the one or more predictions of the incoming behavior relate to one or more of a fan noise level change, a battery level change, a power consumption change, or a skin temperature change.

The series of acts 1200 further include an act 1290 of receiving one or more options to prevent the one or more undesired predictions of the incoming behavior and one or more options to prevent the undesired thermal health predictions. For example, the one or more options may include an option to lower a power submitted to a processor, to increase a fan speed above a noise threshold, to lower a display brightness, to disconnect from a charger, to change to a higher power supply unit (PSU), to disconnect from a network, or to close some applications that are running in the computing device.

The series of acts 1200 further include an act 1292 of providing the one or more predictions of the incoming behavior, the one or more options to prevent the undesired incoming behavior, the one or more thermal health predictions, and the one or more options to prevent the undesired thermal health predictions on a display. For example, the options to prevent the undesired incoming behavior and the undesired thermal health predictions may be displayed on a remote display or on a display that is an integral part of the computing device.

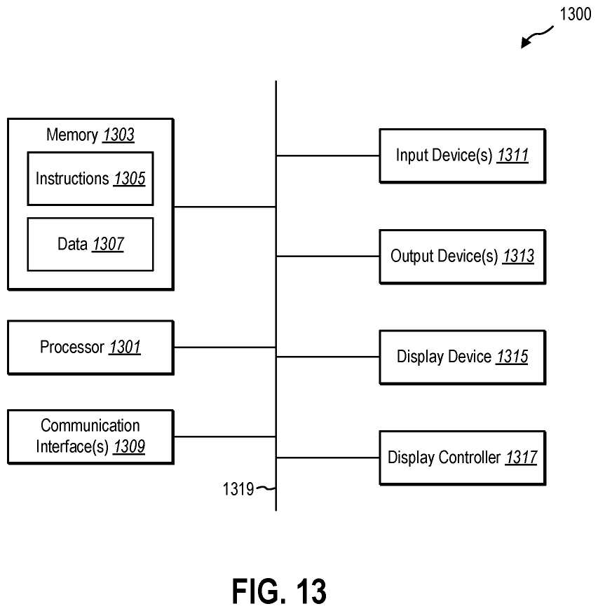

FIG. 13 illustrates certain components that may be included within a computing device 1300. The computing device 1300 may be used to implement the various computing devices, components, and systems described herein (e.g., by performing computer-implemented instructions). As used herein, a “computing device” refers to electronic components that perform a set of operations based on a set of programmed instructions. Computing devices include groups of electronic components, client devices, server devices, etc.

In various implementations, the computing device 1300 represents one or more of the client devices, server devices, or other computing devices described above. For example, the computing device 1300 may refer to various types of network devices capable of accessing data on a network, a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computing device 1300 includes a processing system including a processor 1301. The processor 1301 may be a general-purpose single- or multi-chip microprocessor (e.g., an Advanced Reduced Instruction Set Computer (RISC) Machine (ARM)), a special-purpose microprocessor (e.g., a digital signal processor (DSP)), a microcontroller, a programmable gate array, etc. The processor 1301 may be referred to as a central processing unit (CPU) and may cause computer-implemented instructions to be performed. Although the processor 1301 shown is just a single processor in the computing device 1300 of FIG. 13, in an alternative configuration, a combination of processors (e.g., an ARM and DSP) could be used.

The computing device 1300 also includes memory 1303 in electronic communication with the processor 1301. The memory 1303 may be any electronic component capable of storing electronic information. For example, the memory 1303 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 1305 and the data 1307 may be stored in the memory 1303. The instructions 1305 may be executable by the processor 1301 to implement some or all of the functionality disclosed herein. Executing the instructions 1305 may involve the use of the data 1307 that is stored in the memory 1303. Any of the various examples of modules and components described herein may be implemented, partially or wholly, as instructions 1305 stored in memory 1303 and executed by the processor 1301. Any of the various examples of data described herein may be among the data 1307 that is stored in memory 1303 and used during the execution of the instructions 1305 by the processor 1301.

A computing device 1300 may also include one or more communication interface(s) 1309 for communicating with other electronic devices. The one or more communication interface(s) 1309 may be based on wired communication technology, wireless communication technology, or both. Some examples of the one or more communication interface(s) 1309 include a Universal Serial Bus (USB), an Ethernet adapter, a wireless adapter that operates according to an Institute of Electrical and Electronics Engineers (IEEE) 702.11 wireless communication protocol, a Bluetooth® wireless communication adapter, and an infrared (IR) communication port.

A computing device 1300 may also include one or more input device(s) 1311 and one or more output device(s) 1313. Some examples of the one or more input device(s) 1311 include a keyboard, mouse, microphone, remote control device, button, joystick, trackball, touchpad, and light pen. Some examples of the one or more output device(s) 1313 include a speaker and a printer. A specific type of output device that is typically included in a computing device 1300 is a display device 1315. The display device 1315 used with implementations disclosed herein may utilize any suitable image projection technology, such as liquid crystal display (LCD), light-emitting diode (LED), gas plasma, electroluminescence, or the like. A display controller 1317 may also be provided, for converting data 1307 stored in the memory 1303 into text, graphics, and/or moving images (as appropriate) shown on the display device 1315.

The various components of the computing device 1300 may be coupled together by one or more buses, which may include a power bus, a control signal bus, a status signal bus, a data bus, etc. For clarity, the various buses are illustrated in FIG. 13 as a bus system 1319.

This disclosure describes a subjective data application system in the framework of a network. In this disclosure, a “network” refers to one or more data links that enable electronic data transport between computer systems, modules, and other electronic devices. A network may include public networks such as the Internet as well as private networks. When information is transferred or provided over a network or another communication connection (either hardwired, wireless, or both), the computer correctly views the connection as a transmission medium. Transmission media can include a network and/or data links that carry required program code in the form of computer-executable instructions or data structures, which can be accessed by a general-purpose or special-purpose computer.

In addition, the network described herein may represent a network or a combination of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which one or more computing devices may access the various systems described in this disclosure. Indeed, the networks described herein may include one or multiple networks that use one or more communication platforms or technologies for transmitting data. For example, a network may include the Internet or other data link that enables transporting electronic data between respective client devices and components (e.g., server devices and/or virtual machines thereon) of the cloud computing system.

Further, upon reaching various computer system components, program code means in the form of computer-executable instructions or data structures can be transferred automatically from transmission media to non-transitory computer-readable storage media (devices), or vice versa. For example, computer-executable instructions or data structures received over a network or data link can be buffered in random-access memory (RAM) within a network interface module (NIC), and then it is eventually transferred to computer system RAM and/or to less volatile computer storage media (devices) at a computer system. Thus, it should be understood that computer-readable storage media (devices) can be included in computer system components that also (or even primarily) utilize transmission media.

Computer-executable instructions include instructions and data that, when executed by a processor, cause a general-purpose computer, special-purpose computer, or special-purpose processing device to perform a certain function or group of functions. In some implementations, computer-executable and/or computer-implemented instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or a combination of hardwired and wireless data links) through a network, both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium, including instructions that, when executed by at least one processor, perform one or more of the methods described herein (including computer-implemented methods). The instructions may be organized into routines, programs, objects, components, data structures, etc., which may perform particular tasks and/or implement particular data types, and which may be combined or distributed as desired in various implementations.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, implementations of the disclosure can include at least two distinctly different kinds of computer-readable media: non-transitory computer-readable storage media (devices) and transmission media.

As used herein, computer-readable storage media (devices) may include RAM, ROM, EEPROM, CD-ROM, solid-state drives (SSDs) (e.g., based on RAM), Flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general-purpose or special-purpose computer.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for providing one or more predictions of incoming behavior of a computing device, comprising:
receiving computing device measurement data;
providing the computing device measurement data as an input to a virtual thermal device;
receiving, from the virtual thermal device, the one or more predictions of the incoming behavior of the computing device based on the computing device measurement data; and
providing the one or more predictions of the incoming behavior on a display.

2. The method of claim 1, wherein the computing device measurement data is received from one or more sensors.

3. The method of claim 1, wherein the computing device measurement data includes one or more of a CPU temperature, a GPU temperature, a CPU power usage, a GPU power usage, a battery temperature, an ambient temperature, a display brightness measurement, a battery charge and discharge measurements, and a fan rotation speed measurement.

4. The method of claim 1, wherein the virtual thermal device is a prediction model build from a simulation data.

5. The method of claim 1, wherein the one or more predictions of the incoming behavior relate to one or more of a fan noise level change, a battery level change, a power consumption change, or a skin temperature change.

6. The method of claim 1, further including receiving telemetry data and providing the telemetry data as the input to the virtual thermal device.

7. The method of claim 6, wherein the telemetry data includes one or more of information about applications that are running in the computing device or communication interfaces being used.

8. A method for providing one or more predictions of incoming behavior of a computing device and one or more options to prevent undesired incoming behavior, comprising:
receiving computing device measurement data;
providing the computing device measurement data as an input to a virtual thermal device;
receiving, from the virtual thermal device, the one or more predictions of the incoming behavior of the computing device based on the computing device measurement data;
receiving the one or more options to prevent the undesired incoming behavior; and
providing the one or more predictions of the incoming behavior and the one or more options to prevent the undesired incoming behavior on a display.

9. The method of claim 8, wherein the one or more predictions of the incoming behavior relate to one or more of a fan noise level change, a battery level change, a power consumption change, or a skin temperature change.

10. The method of claim 9, wherein the skin temperature change is the skin temperature change on one or more of a keycap, on a palm-rest, on a touch pad, on a display, or on an outer surface.

11. The method of claim 8, wherein the one or more options include one or more of an option to lower a power submitted to a processor, an option to increase a fan speed above a noise threshold, an option to lower a display brightness, an option to disconnect from a charger, an option to change to a higher power supply unit (PSU), an option to disconnect from a network, or an option to close one or more applications that are running in the computing device.

12. The method of claim 8, wherein at least one of the one or more predictions of the incoming behavior is the undesired incoming behavior.

13. A method for providing one or more options to prevent undesired incoming behavior of a computing device, and providing one or more options to prevent undesired thermal health predictions of the computing device, comprising:
receiving computing device measurement data;
receiving telemetry data of the computing device;
receiving history data of the computing device;
providing the computing device measurement data, the telemetry data, and the history data as an input to a virtual thermal device;
receiving, from the virtual thermal device, one or more predictions of an incoming behavior of the computing device based on the computing device measurement data and the telemetry data, and one or more thermal health predictions based on the history data;
receiving the one or more options to prevent the undesired incoming behavior and the one or more options to prevent the undesired thermal health predictions; and
providing the one or more predictions of the incoming behavior, the one or more options to prevent the undesired incoming behavior, the one or more thermal health predictions, and the one or more options to prevent the undesired thermal health predictions on a display.

14. The method of claim 13, wherein the history data includes long-term measurement data and long-term telemetry data collected over a long period of time.

15. The method of claim 13, wherein the computing device measurement data and the telemetry data are real-time data.

16. The method of claim 13, wherein the telemetry data includes information about one or more of applications that are running in the computing device or a communication interface being used.

17. The method of claim 16, wherein the communication interface is one or more of a Universal Serial Bus (USB), a Bluetooth wireless communication adapter, or a wireless adapter (Wi-Fi).

18. The method of claim 13, wherein the one or more thermal health predictions predict long-term failures of a hardware component.

19. The method of claim 18, wherein the hardware component is one or more of a battery, a display, a CPU, a GPU, or a thermal management system of the computing device.

20. The method of claim 13, wherein the one or more predictions of the incoming behavior relate to one or more of a fan noise level change, a battery level change, a power consumption change, or a skin temperature change.
